(19) United States
(12) Patent Application Publication
(10) Pub. No.: US 2024/0387983 A1
(43) Pub. Date: Nov. 21, 2024

(54) BASE STATION

(71) Applicant: AUTEL ROBOTICS CO., LTD., Nanshan Dist.hen (CN)

(72) Inventor: Jianping SONG, Shenzhen (CN)

(21) Appl. No.: 18/666,377

(22) Filed: May 16, 2024

(30) Foreign Application Priority Data
May 16, 2023 (CN) 202310552263.2

(51) Int. Cl. H01Q 1/24; H01Q 19/10; H04B 7/06

(52) U.S. Cl. CPC H01Q 1/246; H01Q 19/104; H04B 7/0608

(57) ABSTRACT

Embodiments of the present disclosure relate to the field of wireless communication technologies. A base station is disclosed, including a metal body, at least two antennas and a switching component. The metal body is provided with at least two corner parts and the at least two corner parts are oriented in different directions. One antenna is disposed at a corner part and the corner part is configured to reflect a signal radiated by the antenna to enable a combination of directions of signals radiated by the at least two antennas to cover all directions on a horizontal plane. The at least two antennas are all connected to the switching component to enable an antenna with a strongest signal among the at least two antennas to work.

### CROSS REFERENCE TO RELATED DISCLOSURE

This disclosure is filed based upon and claims priority to Chinese patent disclosure 202310552263.2, filed on May 16, 2023 and entitled “Base station” the entire disclosure of which is incorporated herein by reference for all purposes.

### BACKGROUND

When performing a task, an unmanned aerial vehicle needs to communicate with a ground device, so that a ground base station obtains information about the unmanned aerial vehicle. Because the unmanned aerial vehicle can fly in any direction in the sky, signals radiated by an antenna in the base station need to cover all directions above the ground, to ensure that the base station can maintain communication with the unmanned aerial vehicle at any time.

During implementation of embodiments of the present disclosure, the inventor finds that a distance between the unmanned aerial vehicle and the base station is usually long. In this case, if the antenna is intended to achieve omnidirectional signal coverage, a size of the antenna needs to be designed long, which is not beneficial for miniaturization design of the base station.

### SUMMARY

Embodiments of the present disclosure relate to the field of wireless communication technologies, and in particular, to a base station.

A technical problem mainly solved in embodiments of the present disclosure is to provide a base station, to achieve omnidirectional signal coverage above the ground and be beneficial for miniaturized design of the base station.

According to a first aspect of the present disclosure is to provide a base station, comprises: a metal body, at least two antennas and a switching component. The metal body is provided with at least two corner parts, where the at least two corner parts are oriented in different directions. One antenna is disposed at one corner part and the corner part of the antenna is configured to reflect a signal radiated by the antenna to enable a combination of directions of signals radiated by the at least two antennas to cover all directions on a horizontal plane. The at least two antennas are all connected to the switching component to enable an antenna with a strongest signal among the at least two antennas to work.

### BRIEF DESCRIPTION OF THE DRAWINGS

To describe the technical solutions in specific embodiments of the present disclosure or in the prior art more clearly, the following briefly describes the accompanying drawings required for describing specific embodiments of the present disclosure or the prior art. In all the accompanying drawings, similar elements or parts are usually identified by similar reference numerals. In the accompanying drawings, each element or part is not necessarily drawn to an actual proportion.

FIG. 1 is a schematic diagram of a structure of a base station according to an embodiment of the present disclosure;

FIG. 2 is a schematic diagram of a connection relationship between a plurality of switching switch assemblies and a plurality of antennas according to an embodiment of the present disclosure;

FIG. 3 is a schematic diagram of a structure of a metal body according to an embodiment of the present disclosure at a first viewing angle;

FIG. 4 is a schematic diagram of a structure of a metal body according to an embodiment of the present disclosure at a second viewing angle;

FIG. 5 is a schematic diagram of a structure of an antenna according to an embodiment of the present disclosure;

FIG. 6 is a schematic exploded diagram of an antenna according to an embodiment of the present disclosure;

FIG. 7 is a schematic diagram of a structure of a first radiating module according to an embodiment of the present disclosure;

FIG. 8 is an enlarged view of an area shown in part A in FIG. 7;

FIG. 9 is a schematic diagram of a structure of a second radiating module according to an embodiment of the present disclosure;

FIG. 10 is an enlarged view of an area shown in part B in FIG. 9;

FIG. 11 is a schematic diagram of a structure of a second radiating module when a first connection part and a second connection part are disposed in a bending manner according to an embodiment of the present disclosure;

FIG. 12 is an S11 parameter diagram of a base station in a first frequency band signal and a second frequency band signal according to an embodiment of the present disclosure;

FIG. 13 is a direction pattern of a first frequency band signal of a base station on a horizontal plane according to an embodiment of the present disclosure;

FIG. 14 is a direction pattern of a second frequency band signal of a base station on a horizontal plane according to an embodiment of the present disclosure;

FIG. 15 is an S11 parameter diagram of a base station in a third frequency band signal and a fourth frequency band signal according to an embodiment of the present disclosure;

FIG. 16 is a direction pattern of a third frequency band signal of a base station on a horizontal plane according to an embodiment of the present disclosure; and

FIG. 17 is a direction pattern of a fourth frequency band signal of a base station on a horizontal plane according to an embodiment of the present disclosure.

### DETAILED DESCRIPTION

For ease of understanding the present disclosure, the present disclosure is described in more detail below with reference to the accompanying drawings and specific embodiments. It should be noted that when an element is described as being “fixed” on another element, the element may be directly on the another element, or one or more intermediate elements may exist therebetween. When an element is described as being “connected” to another element, the element may be directly connected to the another element, or one or more intermediate elements may exist therebetween. In this specification, orientation or position relationships indicated by the terms such as “up”, “down”, “inside”, “outside”, “vertical” and “horizontal” are based on orientation or position relationships shown in the accompanying drawings, and are used only for ease and brevity of illustration and description of the present disclosure, rather than indicating or implying that the mentioned apparatus or element needs to have a particular orientation or needs to be constructed and worked in a particular orientation. Therefore, such terms should not be construed as limiting of the present disclosure. In addition, terms “first”, “second” and the like are only used to describe the objective and cannot be understood as indicating or implying relative importance.

Unless otherwise defined, meanings of all technical and scientific terms used in the present disclosure are the same as that usually understood by a person skilled in the art to which the present disclosure belongs. Terms used in the specification of the present disclosure are merely intended to describe objectives of specific embodiments, and are not intended to limit the present disclosure. A term “and/or” used in this specification includes any or all combinations of one or more related listed items.

In addition, technical features involved in different embodiments of the present disclosure described below may be combined together if there is no conflict.

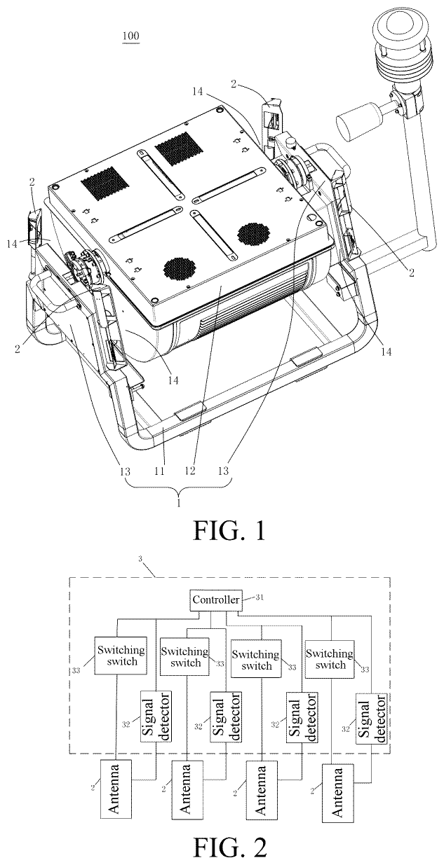

Referring to FIG. 1 and FIG. 2, a base station 100 includes a metal body 1, a switching component 3 and at least two antennas 2. The at least two antennas 2 are all disposed on the metal body 1 and the at least two antennas 2 are oriented in different directions to enable a combination of directions of signals radiated by the at least two antennas 2 to cover all directions on a horizontal plane. The at least two antennas 2 are all connected to the switching component 3 and the switching component 3 is configured to control the at least two antennas 2 to enable an antenna with a strongest signal of the at least two antennas 2 to work and ensure a sufficiently long signal transmission distance of the base station 100.

The metal body 1 includes a bracket 11, a metal chamber 12 and two metal panels 13. The metal chamber 12 and the two metal panels 13 are all mounted on the bracket 11. The two metal panels 13 are respectively located at two ends of the metal chamber 12. At least two corner parts 14 are formed between the metal chamber 12 and the two metal panels 13. Openings (not numbered) of the at least two corner parts 14 are oriented in different directions. Two side walls located at two ends of the metal chamber 12 and side walls of the two metal panels 13 collectively form metal wall surfaces of the at least two corner parts 14. An antenna 2 is located at a corner part 14. Because the metal wall surface of the corner part 14 has a reflection effect on a signal radiated by the antenna 2, each antenna 2 has a strong ability to radiate a signal in some specific angular ranges and a weak ability to radiate a signal in a direction out of the specific angular ranges. Therefore, at least two antennas 2 are disposed at the at least two corner parts 14 respectively and the openings of the at least two corner parts 14 are oriented in different directions, so that when the antennas 2 are combined, omnidirectional coverage on the horizontal plane can be achieved. Then, the at least two antennas 2 are controlled by using the switching component 3 to enable the antenna with the strongest signal to work. In this way, omnidirectional coverage of signals radiated by the base station 100 on the horizontal plane is achieved, a radiation distance of the base station 100 is ensured and only the antenna with the strongest signal works, which reduces energy required by the base station 100.

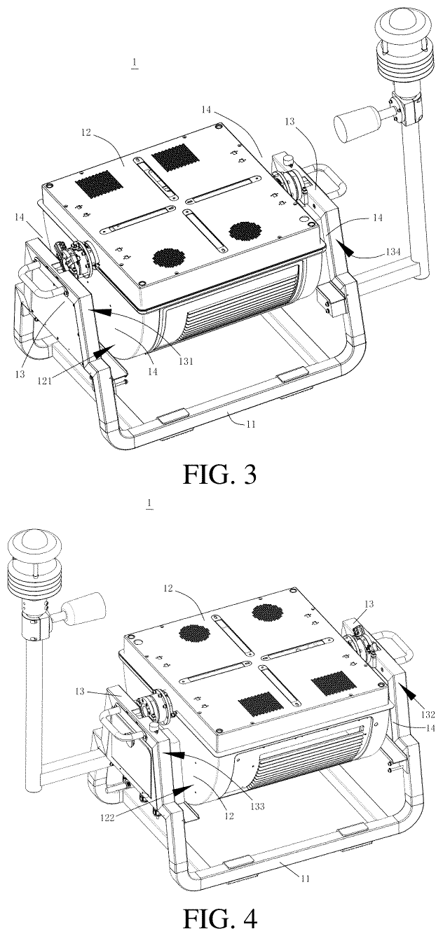

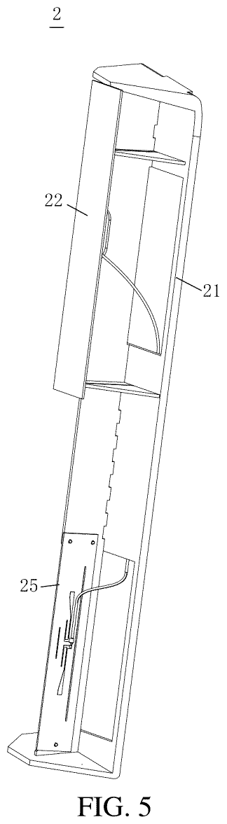

In some embodiments, referring to FIG. 3 and FIG. 4, four corner parts 14 are formed between the metal chamber 12 and the two metal panels 13. Specifically, the metal chamber 12 has a first end surface 121 and a second end surface 122 that are opposite, a metal panel 13 has a third end surface 131 and a fourth end surface 132 that are oppositely disposed and the other metal panel 13 has a fifth end surface 133 and a sixth end surface 134 that are oppositely disposed. Corner parts 14 are formed between the third end surface 131 and the first end surface 121, between the fourth end surface 132 and the first end surface 121, between the fifth end surface 133 and the second end surface 122 and between the sixth end surface 134 and the second end surface 122. A quantity of antennas 2 is also four, one antenna 2 is located at one corner part 14, and angles between orientations of openings of adjacent corner parts 14 are the same, in other words, an angle between orientations of openings of adjacent two corner parts 14 is 90°, and the first end surface 121, the second end surface 122, the third end surface 131, the fourth end surface 132, the fifth end surface 133 and the sixth end surface 134 may all reflect signals radiated by the antennas 2, so that when the antennas 2 are combined, the omnidirectional coverage on the horizontal plane can be achieved.

In some embodiments, referring to FIG. 1 to FIG. 4, the third end surface 131, the fourth end surface 132, the fifth end surface 133 and the sixth end surface 134 all tilt toward the sky, to enhance strength of a signal obliquely above the metal body 1.

In some embodiments, none of length directions of the four antennas 2 is perpendicular to the horizontal plane, so that a signal blind area directly above the antennas 2 can be avoided.

The switching component 3 includes a controller 31, at least two signal detectors 32 and at least two switching assembly 33. One signal detector 32 is connected to one antenna 2 and the signal detectors 32 are all connected to the controller 31. One switching switch 33 is connected to one antenna 2 and switching assembly 33 are all connected to the controller 31. The signal detector 32 is configured to detect strength of the signal radiated by the antenna 2 connected to the signal detector 32. All signal detectors 32 transmit detected signals to the controller 31, and the controller 31 determines strength of the signals detected by the signal detectors 32. The controller 31 controls a switching switch 33 connected to an antenna 2 with the strongest signal to be turned on and the controller 31 controls other switching assembly 33 to be turned off, so that only the antenna 2 with the strongest signal is in a working state, which can reduce the energy required by the base station 100.

When an airborne object flies, as a position changes, the airborne object gradually leaves a radiation area of the antenna 2 in the working state. Because only the antenna 2 with the strongest signal in the base station 100 works, when the signal detector 32 connected to the antenna 2 in the working state detects that the signal strength is lower than a preset value, the controller 31 controls all switching assembly 33 to be turned on and all the antennas 2 start to work. In this case, all signal detectors 32 transmit detected signals to the controller 31 and the controller 31 determines strength of the signals detected by the signal detectors 32. The controller 31 controls a switching switch 33 connected to an antenna 2 with the strongest signal to be turned on and the controller 31 controls other switching assembly 33 to be turned off, so that the base station 100 can remain in communication with the airborne object at any time.

Structures of the four antennas 2 are completely the same, and a difference is that mounting positions and orientations of the four antennas 2 are different. Therefore, only a structure of an antenna 2 located at the corner part 14 formed by the first end surface 121 and the third end surface 131 is described in detail below. The reader needs to recall a structure of an antenna 2 located at another corner part 14. Details are not described herein again.

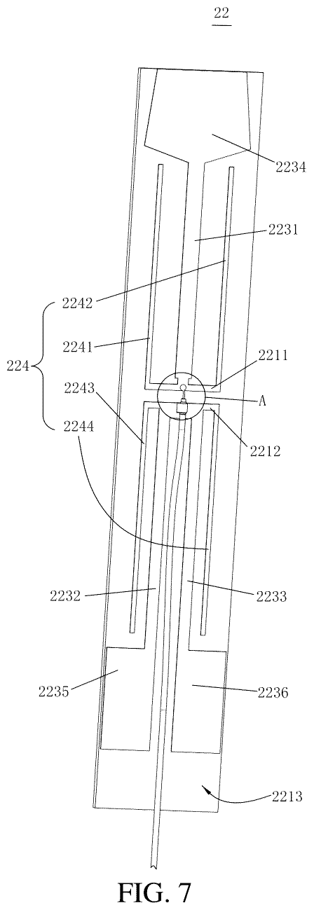

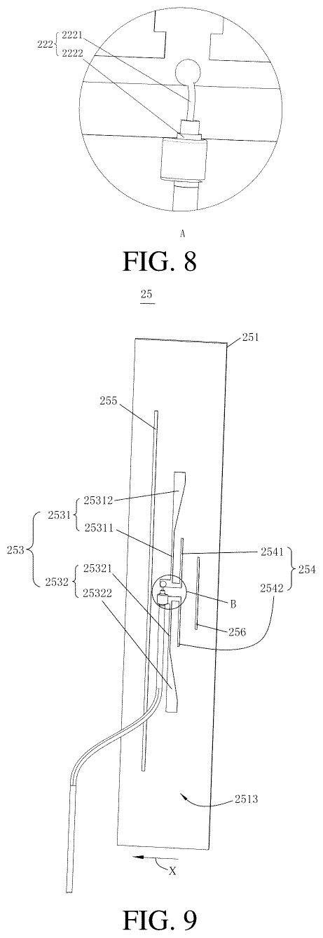

Referring to FIG. 1 to FIG. 8, the antenna 2 includes an antenna bracket 21, a first radiating module 22, a duplexer assembly 23, a feedline bus 24 and a second radiating module 25. The antenna bracket 21 is mounted at a corner part 14 and the first radiating module 22, the duplexer assembly 23 and the second radiating module 25 are all disposed on the antenna bracket 21. The first radiating module 22 and the second radiating module 25 are both connected to the duplexer assembly 23. The first radiating module 22 is configured to radiate a first frequency band signal and a second frequency band signal. The second radiating module 25 is configured to radiate a third frequency band signal and a fourth frequency band signal. The duplexer assembly 23 is configured to transmit signals radiated by the first radiating module 22 and the second radiating module 25 to the feedline bus 24. One end of the feedline bus 24 is connected to the duplexer assembly 23 and the other end of the feedline bus 24 is connected to the switching switch 33. The switching switch 33 is further connected to a main board (not shown in the figure) of the base station 100, so that the switching switch 33 can control conduction or disconnection between the duplexer assembly 23 and the main board of the base station 100 to control working of the antenna 2.

The first radiating module 22 includes a first dielectric plate 221, a first feedline 222, a first radiating assembly 223 and a second radiating assembly 224. The first dielectric plate 221 is mounted on the antenna bracket 21, and a first surface 2213 of the first dielectric plate 221 is oriented to a corner of the corner part 14. The first radiating assembly 223 and the second radiating assembly 224 are both disposed on the first surface 2213 of the first dielectric plate 221, the first radiating assembly 223 and the second radiating assembly 224 are both connected to one end of the first feedline 222 and the other end of the first feedline 222 is connected to the duplexer assembly 23. The first radiating assembly 223 is configured to radiate the first frequency band signal, the second radiating assembly 224 is configured to radiate the second frequency band signal and the first feedline 222 is configured to transmit the first frequency band signal radiated by the first radiating assembly 253 and the second frequency band signal radiated by the second radiating assembly 224 to the duplexer assembly 23, so that the first frequency band signal and the second frequency band signal transmitted to the duplexer assembly 23 are transmitted to the feedline bus 24 and when the switching switch 33 connected to the feedline bus 24 is in a conducted state, both the first frequency band signal and the second frequency band signal can be transmitted to the main board of the base station 100 by using the switching switch 33. The antenna bracket 21 is mounted at the corner part 14 and the first surface 2213 of the first dielectric plate 221 is oriented to the corner of the corner part 14, so that the first radiating assembly 223 and the second radiating assembly 224 are both disposed on the first surface 2213. When the first radiating assembly 223 or the second radiating assembly 224 radiates signals, a part of the signals are radiated in a direction of the first end surface 121 or the third end surface 131. When the signals are radiated to the first end surface 121 or the third end surface 131, the first end surface 121 or the third end surface 131 reflects the signals, to enhance strength of a signal in a direction to which the opening of the corner part 14 is oriented.

Specifically, a frequency range of the first frequency band signal is greater than or equal to 0.80 GHz and less than or equal to 0.91 GHz and a frequency range of the second frequency band signal is greater than or equal to 1.34 GHz and less than or equal to 1.45 GHz. Because the first frequency band signal and the second frequency band signal have low frequencies and long wavelengths, even if the first end surface 121 and the third end surface 131 have irregular shapes and large areas, only few weak and discontinuous scattered currents are generated when the metal chamber 12 and the metal panel 13 reflects the first frequency band signal and the second frequency band signal as reflectors, to ensure that fluctuations of the first frequency band signal and the second frequency band signal at different angles are small.

A first feeding part 2211 and a second feeding part 2212 are disposed on the first surface 2213 of the first dielectric plate 221 and the first feeding part 2211 and the second feeding part 2212 are disposed separately. The first feedline 222 includes a first inner conductor 2221 and a first outer conductor 2222. The first inner conductor 2221 and the first outer conductor 2222 are insulated from each other. The first inner conductor 2221 is electrically connected to the first feeding part 2211 and the first outer conductor 2222 is electrically connected to the second feeding part 2212.

The first radiating assembly 223 includes a first radiating arm 2231, a second radiating arm 2232 and a third radiating arm 2233. One end of the first radiating arm 2231 is connected to the first feeding part 2211 and the other end of the first radiating arm 2231 extends in a direction away from the second feeding part 2212. One end of the second radiating arm 2232 and one end of the third radiating arm 2233 are both connected to the second feeding part 2212. The other end of the second radiating arm 2232 and the other end of the third radiating arm 2233 extends in a direction away from the first feeding part 2211. The first radiating arm 2231, the second radiating arm 2232, the third radiating arm 2233, the first feeding part 2211 and the second feeding part 2212 may collectively form a radiating unit, so that the first radiating arm 2231, the second radiating arm 2232 and the third radiating arm 2233 can collectively radiate the first frequency band signal.

In some embodiments, the first radiating assembly 223 further includes a first stub 2234, a second stub 2235 and a third stub 2236. The first stub 2234 is connected to the other end of the first radiating arm 2231, the second stub 2235 is connected to the other end of the second radiating arm 2232 and the third stub 2236 is connected to the other end of the third radiating arm 2233. The second stub 2235 is located on a side of the second radiating arm 2232 away from the third radiating arm 2233 and the third stub 2236 is located on a side of the third radiating arm 2233 away from the second radiating arm 2232. The first stub 2234, the second stub 2235 and the third stub 2236 are configured to adjust a resonant frequency of the first radiating assembly 223, so that a frequency of a signal radiated by the first radiating assembly 223 can fall within a first frequency band while lengths of the first radiating arm 2231, the second radiating arm 2232 and the third radiating arm 2233 can be shortened, which helps reduce a size of the antenna 2, to help reduce a volume of the base station 100.

Further, the second radiating arm 2232 and the third radiating arm 2233 are parallel to each other.

Further, viewed from a direction perpendicular to the first surface 2213 of the dielectric plate, the second radiating arm 2232 and the third radiating arm 2233 are symmetric to each other and the second stub 2235 and the third stub 2236 are symmetric to each other.

Further, in a length direction of the first radiating arm 2231, a sum of lengths of the first radiating arm 2231 and the first stub 2234, a sum of lengths of the second radiating arm 2232 and the second stub 2235 and a sum of lengths of the third radiating arm 2233 and the third stub 2236 are all greater than or equal to ⅛ of a wavelength of the first frequency band signal and less than or equal to ¾ of the wavelength of the first frequency band signal. Specifically, based on an intermediate frequency 0.855 GHz of the first frequency band signal, the sum of the lengths of the first radiating arm 2231 and the first stub 2234, the sum of the lengths of the second radiating arm 2232 and the second stub 2235 and the sum of the lengths of the third radiating arm 2233 and the third stub 2236 are all greater than or equal to 43.86 mm and less than or equal to 263.15 mm, so that the first radiating assembly 223 can radiate the first frequency band signal.

The second radiating assembly 224 includes a fourth radiating arm 2241, a fifth radiating arm 2242, a sixth radiating arm 2243 and a seventh radiating arm 2244. One end of the fourth radiating arm 2241 and one end of the fifth radiating arm 2242 are both connected to the first feeding part 2211 and the fourth radiating arm 2241 and the fifth radiating arm 2242 are respectively located on two sides of the first radiating arm 2231. One end of the sixth radiating arm 2243 and one end of the seventh radiating arm 2244 are both connected to the second feeding part 2212. The sixth radiating arm 2243 is located on the side of the second radiating arm 2232 away from the third radiating arm 2233 and the seventh radiating arm 2244 is located on the side of the third radiating arm 2233 away from the second radiating arm 2232. The fourth radiating arm 2241, the fifth radiating arm 2242, the sixth radiating arm 2243, the seventh radiating arm 2244, the first feeding part 2211 and the second feeding part 2212 collectively form another radiating unit, so that the fourth radiating arm 2241, the fifth radiating arm 2242, the sixth radiating arm 2243 and the seventh radiating arm 2244 can collectively radiate the second frequency band signal.

In some embodiments, the fourth radiating arm 2241 and the fifth radiating arm 2242 are symmetric with respect to the first radiating arm 2231.

In some embodiments, viewed from the direction perpendicular to the first surface 2213, the sixth radiating arm 2243 and the seventh radiating arm 2244 are symmetric to each other.

In some embodiments, viewed in the direction perpendicular to the first surface 2213, the fourth radiating arm 2241 and the sixth radiating arm 2243 are symmetric to each other and the fifth radiating arm 2242 and the seventh radiating arm 2244 are symmetric to each other.

Further, in the length direction of the first radiating arm 2231, lengths of the fourth radiating arm 2241, the fifth radiating arm 2242, the sixth radiating arm 2243 and the seventh radiating arm 2244 are all greater than or equal to ⅛ of a wavelength of the second frequency band signal and less than or equal to ¾ of the wavelength of the second frequency band signal. Specifically, calculated at an intermediate frequency 1.395 GHz of the second frequency band signal, the lengths of the fourth radiating arm 2241, the fifth radiating arm 2242, the sixth radiating arm 2243 and the seventh radiating arm 2244 are all greater than or equal to 26.88 mm and less than or equal to 161.29 mm, so that the second radiating assembly 224 can radiate the second frequency band signal.

It should be noted that the first radiating arm 2231 is not perpendicular to the horizontal plane and the second radiating arm 2232 is also not perpendicular to the horizontal plane. In this way, a blind area between the first frequency band signal and the second frequency band signal can be prevented from being formed directly above the antenna 2, to prevent the blind area between the first frequency band signal and the second frequency band signal from being formed above the base station 100. The length direction of the antenna 2 is the same as the length direction of the first radiating arm 2231, so that the length direction of the antenna 2 is not perpendicular to the horizontal plane.

The second radiating module 25 includes a second dielectric plate 251, a second feedline 252, a third radiating assembly 253 and a fourth radiating assembly 254. The second dielectric plate 251 is mounted on the antenna bracket 21 and the first dielectric plate 221 and the second dielectric plate 251 are distributed in a length direction of the antenna bracket 21. The second dielectric plate 251 has a second surface 2513 and the second surface 2513 is oriented outwards through the corner part 14. The third radiating assembly 253 and the fourth radiating assembly 254 are both disposed on the second surface 2513 of the second dielectric plate 251, the third radiating assembly 253 and the fourth radiating assembly 254 are both connected to one end of the second feedline 252 and the other end of the second feedline 252 is connected to the duplexer assembly 23. The third radiating assembly 253 is configured to radiate a third frequency band signal, the fourth radiating assembly 254 is configured to radiate a fourth frequency band signal and the second feedline 252 is configured to transmit the third frequency band signal radiated by the third radiating assembly 253 and the fourth frequency band signal radiated by the fourth radiating assembly 254 to the duplexer assembly 23, so that the first frequency band signal, the second frequency band signal, the third frequency band signal and the fourth frequency band signal transmitted to the duplexer assembly 23 are transmitted to the feedline bus 24, and when the switching switch 33 connected to the feedline bus 24 is in a conducted state, all the first frequency band signal, the second frequency band signal, the third frequency band signal and the fourth frequency band signal can be transmitted to the main board of the base station 100 by using the switching switch 33.

A frequency range of the third frequency band signal is greater than or equal to 2.23 GHz and less than or equal to 2.57 GHz and a frequency range of the fourth frequency band signal is greater than or equal to 5.44 GHz and less than or equal to 5.88 GHZ. Because the third frequency band signal and the fourth frequency band signal have high frequencies, the second surface 2513 of the second dielectric plate 251 is oriented to space out of the corner part 14, so that both the third radiating assembly 253 and the fourth radiating assembly 254 are oriented to the space out of the corner part 14, which can reduce scattered currents generated by reflection of the third frequency band signal and the fourth frequency band signal by the metal chamber 12 and the metal panel 13.

In some embodiments, the second surface 2513 of the second dielectric plate 251 is perpendicular to the first surface 2213 of the first dielectric plate 221. The first surface 2213 is oriented to the corner of the corner part 14 and the second surface 2513 is oriented to the space out of the corner part 14.

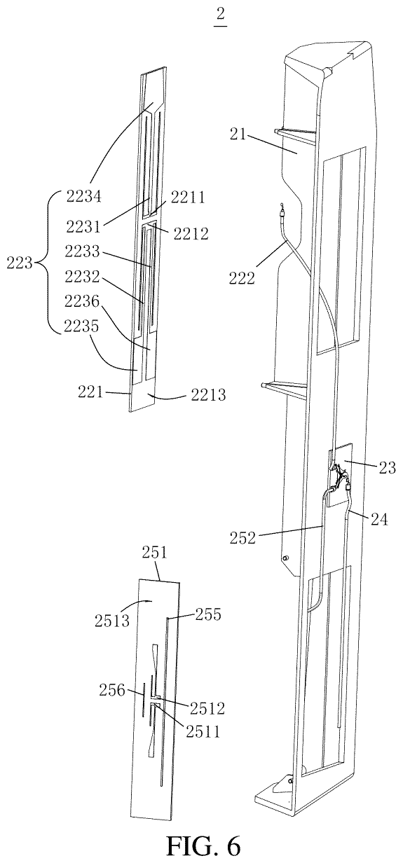

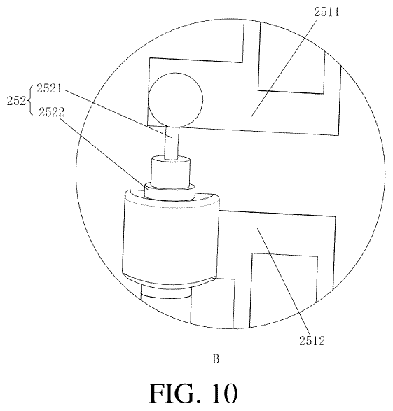

Referring to FIG. 1, FIG. 6, FIG. 9 and FIG. 10, a third feeding part 2511 and a fourth feeding part 2512 are disposed on the second dielectric plate 251. The third feeding part 2511 and the fourth feeding part 2512 are both disposed on the second surface 2513 of the second dielectric plate 251 and the third feeding part 2511 and the fourth feeding part 2512 are disposed separately. The second feedline 252 includes a second inner conductor 2521 and a second outer conductor 2522. The second outer conductor 2522 and the second inner conductor 2521 are disposed in an insulated manner, the second inner conductor 2521 is electrically connected to the third feeding part 2511 and the second outer conductor 2522 is electrically connected to the fourth feeding part 2512.

The third radiating assembly 253 includes an eighth radiating arm 2531 and a ninth radiating arm 2532. One end of the eighth radiating arm 2531 is connected to the third feeding part 2511 and the other end of the eighth radiating arm 2531 extends in a direction away from the fourth feeding part 2512. One end of the ninth radiating arm 2532 is connected to the fourth feeding part 2512 and the other end of the ninth radiating arm 2532 extends in a direction away from the third feeding part 2511. The eighth radiating arm 2531, the ninth radiating arm 2532, the third feeding part 2511 and the fourth feeding part 2512 collectively form still another radiating unit, so that the eighth radiating arm 2531 and the ninth radiating arm 2532 can be collectively configured to radiate the third frequency band signal.

Further, lengths of the eighth radiating arm 2531 and the ninth radiating arm 2532 are both greater than or equal to ⅛ of a wavelength of the third frequency band signal and less than or equal to ¾ of the wavelength of the third frequency band signal. Specifically, calculated based on an intermediate frequency 2.4 GHz of the third frequency band signal, the lengths of the eighth radiating arm 2531 and the ninth radiating arm 2532 are both greater than or equal to 15.63 mm and less than or equal to 93.75 mm, so that the eighth radiating arm 2531 and the ninth radiating arm 2532 can collectively radiate the third frequency band signal.

In some embodiments, the eighth radiating arm 2531 includes a first connection part 25311 and a first widening part 25312. One end of the first connection part 25311 is electrically connected to the third feeding part 2511, the other end of the first connection part 25311 extends in the direction away from the fourth feeding part 2512 and the first widening part 25312 is connected to the other end of the first connection part 25311. The ninth radiating arm 2532 includes a second connection part 25321 and a second widening part 25322. One end of the second connection part 25321 is electrically connected to the fourth feeding part 2512, the other end of the second connection part 25321 extends in the direction away from the third feeding part 2511 and the second widening part 25322 is connected to the other end of the second connection part 25321. The first widening part 25312 and the second widening part 25322 may adjust resonant frequencies of the eighth radiating arm 2531 and the ninth radiating arm 2532 respectively, so that the eighth radiating arm 2531 and the ninth radiating arm 2532 may radiate the third frequency band signal in a short size range, which helps reduce a volume of the antenna 2, to reduce the volume of the base station 100.

Further, the first connection part 25311 extends in a straight line and the second connection part 25321 extends in a straight line.

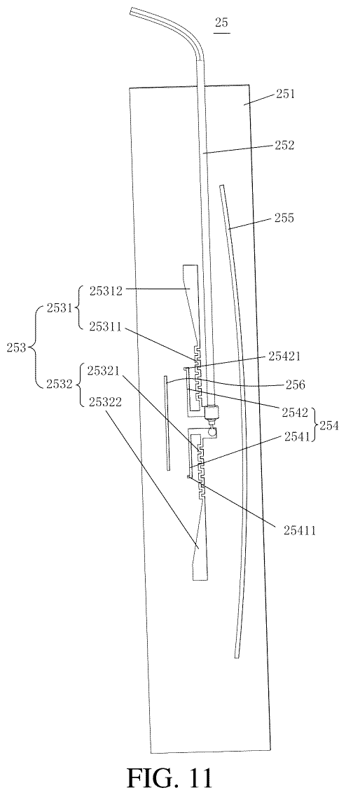

In some embodiments, referring to FIG. 11, the first connection part 25311 is bent and extended in a shape of a rectangular wave, and the second connection part 25321 is also bent and extended in a shape of a rectangular wave, which helps reduce the lengths of the eighth radiating arm 2531 and the ninth radiating arm 2532.

Further, viewed in a direction perpendicular to the second surface 2513, the eighth radiating arm 2531 and the ninth radiating arm 2532 are symmetric to each other.

Referring to FIG. 1, FIG. 6, FIG. 9 and FIG. 10, the fourth radiating assembly 254 includes a tenth radiating arm 2541 and an eleventh radiating arm 2542. One end of the tenth radiating arm 2541 is connected to the third feeding part 2511 and the other end of the tenth radiating arm 2541 extends in the direction away from the fourth feeding part 2512. The eleventh radiating arm 2542 is connected to the fourth feeding part 2512 and the other end of the ninth radiating arm 2542 extends in the direction away from the third feeding part 2511. The tenth radiating arm 2541, the eleventh radiating arm 2542, the third feeding part 2511 and the fourth feeding part 2512 collectively form yet another radiating unit, so that the tenth radiating arm 2541 and the eleventh radiating arm 2542 can be collectively configured to radiate the fourth frequency band signal.

Further, lengths of the tenth radiating arm 2541 and the eleventh radiating arm 2542 are both greater than or equal to ⅛ of a wavelength of the fourth frequency band signal and less than or equal to ¾ of the wavelength of the fourth frequency band signal. Specifically, calculated based on an intermediate frequency 5.66 GHz of the fourth frequency band signal, the lengths of the tenth radiating arm 2541 and the eleventh radiating arm 2542 are both greater than or equal to 6.63 mm and less than or equal to 39.75 mm, so that the tenth radiating arm 2541 and the eleventh radiating arm 2542 can collectively radiate the fourth frequency band signal.

In some embodiments, referring to FIG. 11, a fourth stub 25411 is further disposed on an end of the tenth radiating arm 2541 away from the eleventh radiating arm 2542. A fifth stub 25421 is disposed on an end of the eleventh radiating arm 2542 away from the tenth radiating arm 2541. The fourth stub 25411 and the fifth stub 25421 may adjust resonant frequencies of the tenth radiating arm 2541 and the eleventh radiating arm 2542, so that the tenth radiating arm 2541 and the eleventh radiating arm 2542 may radiate the fourth frequency band signal in a short size range.

Further, viewed in the direction perpendicular to the second surface 2513, the tenth radiating arm 2541 and the eleventh radiating arm 2542 are symmetric.

It should be noted that neither the tenth radiating arm 2541 nor the eleventh radiating arm 2542 is perpendicular to the horizontal plane, to prevent a blind area from being formed between the third frequency band signal and the fourth frequency band signal above the antenna 2, to prevent a blind area from being formed between the third frequency band signal and the fourth frequency band signal above the base station 100.

Referring to FIG. 1, FIG. 6, FIG. 9 and FIG. 10, the second radiating module 25 further includes a reflector 255 and a director 256. The reflector 255 is disposed on the second surface 2513 of the second dielectric plate 251 and is in a direction X perpendicular to a length direction of the eighth radiating arm 2531 and parallel to the second surface 2513. Projection of the eighth radiating arm 2531, the ninth radiating arm 2532, the tenth radiating arm 2541 and the eleventh radiating arm 2542 all fall within projection of the reflector 255, so that the reflector 255 may radiate the third frequency band signal and the fourth frequency band signal in the direction of the opening of the corner part 14. The opening of the corner part 14 is at least partially oriented to the sky. The director 256 is also disposed on the second surface 2513 of the second dielectric plate 251 and the eighth radiating arm 2531, the ninth radiating arm 2532, the tenth radiating arm 2541 and the eleventh radiating arm 2542 are all located between the reflector 255 and the director 256, so that the director 256 can direct the third frequency band signal and the fourth frequency band signal to be radiated in the direction of the opening of the corner part 14. The director 256 and the reflector 255 are disposed to radiate the third frequency band signal and the fourth frequency band signal in the direction of the opening of the corner part 14. The opening of the corner part 14 is at least partially oriented to the sky, to improve strength of the third frequency band signal and the fourth frequency band signal above the metal body 1. In addition, the director 256 and the reflector 255 directly radiate the third frequency band signal and the fourth frequency band signal to the sky, so that the third frequency band signal and the fourth frequency band signal are prevented from being radiated in a direction of the first end surface 121 and the third end surface 131, to avoid a case in which the metal body 1 and the metal panel 13 with irregular shapes reflect the third frequency band signal and the fourth frequency band signal with high frequencies to form large scattered currents. This helps avoid an excessive fluctuation of the signal with angles, effectively improves signal uniformity thereof and reduces a signal blind area.

Further, the reflector 255 extends in a straight line, the director 256 also extends in a straight line and the reflector 255 and the director 256 are parallel to each other.

In some embodiments, referring to FIG. 11, the reflector 255 extends in an arc shape.

To enable the reader to better understand the concept of the present disclosure, experimental proof is performed on the base station 100 as follows.

Because at least two antennas 2 need to be completed together in the present disclosure, to conveniently identify directionality of each antenna 2, an antenna 2 located at a lower left corner in FIG. 1 is referred to as an antenna 1, an antenna 2 located at an upper left corner is referred to as an antenna 2, an antenna 2 located at an upper right corner is referred to as an antenna 3 and an antenna 2 located at a lower right corner is referred to as an antenna 4. In this embodiment of the present disclosure, the metal chamber 12 is mounted on the bracket 11, and the two metal panels 13 are respectively mounted on two ends of the metal chamber 12, so that four corner parts 14 are formed between the two metal panels 13 and the metal chamber 12, the antenna 1, the antenna 2, the antenna 3 and the antenna 4 are respectively disposed at one corner part 14 and work of antennas 2 are controlled by using the switching component, to enable the signal radiated by the base station 100 to cover all directions on the horizontal plane.

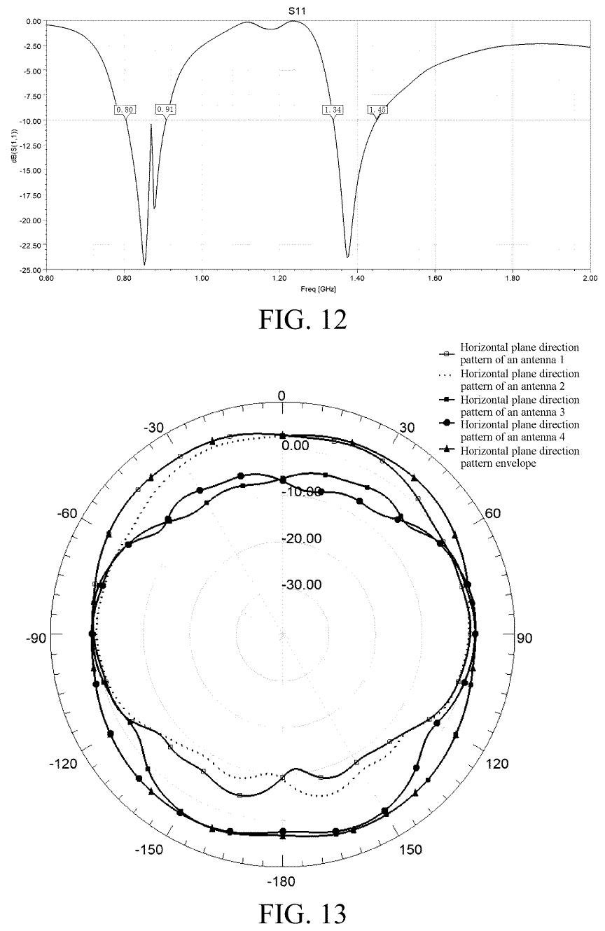

For the first frequency band signal, the base station 100 makes the first surface 2213 of the first dielectric plate 221 in each antenna 2 orient to the corner of the corner part 14 to dispose the first feeding part 2211 and the second feeding part 2212 that are separated from each other on the first surface 2213, connects the first feeding part 2211 to the first inner conductor 2221 of the first feedline 222, connects the first outer conductor 2222 of the first feedline 222 to the second feeding part 2212, connects one end of the first radiating arm 2231 to the first feeding part 2211, connects the first stub 2234 to the other end of the first radiating arm 2231, connects one end of the second radiating arm 2232 and one end of the third radiating arm 2233 to the second feeding part 2212, connects the second stub 2235 to the other end of the second radiating arm 2232 and connects the third stub 2236 to the other end of the third radiating arm 2233. In addition, the first end surface 121, the second end surface 122, the third end surface 131, the fourth end surface 132, the fifth end surface 133 and the sixth end surface 134 reflect the first frequency band signal, and the openings of the corner parts 14 are oriented in different directions, so that the antennas 2 may radiate the first frequency band signal in different directions. Because the third end surface 131, the fourth end surface 132, the fifth end surface 133 and the sixth end surface 134 tilt toward the sky, the first frequency band signal reflected by the third end surface 131, the fourth end surface 132, the fifth end surface 133 and the sixth end surface 134 is mostly radiated to a direction obliquely above the metal body 1, to improve the strength of the first frequency band signal obliquely above the metal body 1. The work of antennas 2 is controlled by using the switching component 3, to enable the first frequency band signal radiated by the base station 100 to cover all directions on the horizontal plane. Referring to FIG. 12, the base station 100 has good circuit performance in a frequency range from 0.80 to 0.91 GHz. With reference to FIG. 13, a line indicated by a horizontal plane pattern of the antenna 1 in FIG. 13 represents directivity of the antenna 1 on the horizontal plane, a line indicated by a horizontal plane pattern of the antenna 2 in FIG. 13 represents directivity of the antenna 2 on the horizontal plane, a line indicated by a horizontal plane pattern of the antenna 3 in FIG. 13 represents directivity of the antenna 3 on the horizontal plane, a line indicated by a horizontal plane pattern of the antenna 4 in FIG. 13 represents directivity of the antenna 4 on the horizontal plane and a line indicated by a horizontal plane pattern envelope in FIG. 13 represents directivity of the base station 100 on the horizontal plane. The line indicated by the horizontal plane pattern envelope is formed by combining parts with best radiation effects of the antenna 1, the antenna 2, the antenna 3, and the antenna 4. It can be learned from FIG. 13 that the first frequency band signal radiated by the base station 100 has omnidirectionality on the horizontal plane.

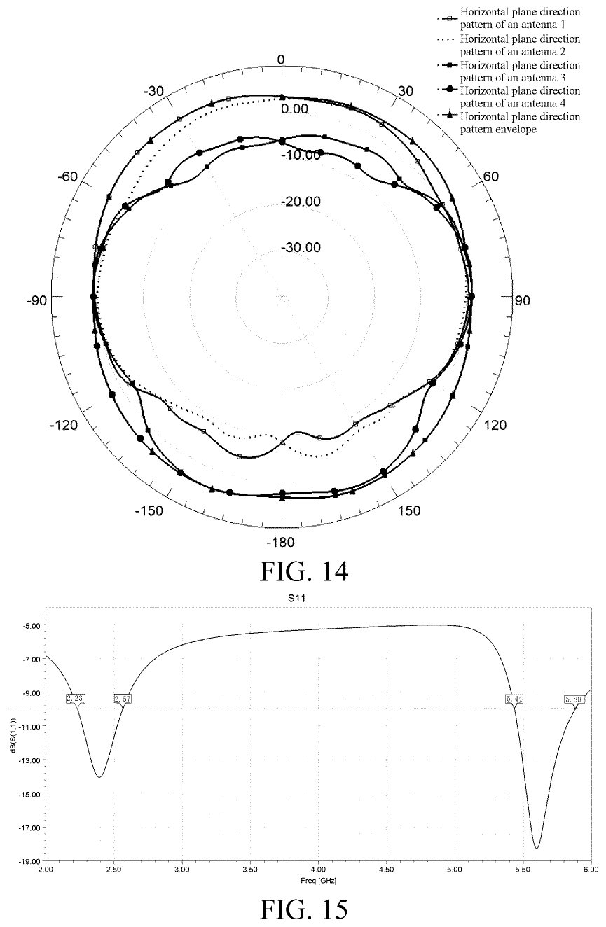

For the second frequency band signal, the base station 100 makes the first surface 2213 of the first dielectric plate 221 in each antenna 2 orient to the corner of the corner part 14 to dispose the first feeding part 2211 and the second feeding part 2212 that are separated from each other on the first surface 2213, connects the first feeding part 2211 to the first inner conductor 2221 of the first feedline 222, connects the first outer conductor 2222 of the first feedline 222 to the second feeding part 2212, connects one end of the fourth radiating arm 2241 and one end of the fifth radiating arm 2242 to the first feeding part 2211 and connects one end of the sixth radiating arm 2243 and one end of the seventh radiating arm 2244 to the second feeding part 2212. In addition, the first end surface 121, the second end surface 122, the third end surface 131, the fourth end surface 132, the fifth end surface 133 and the sixth end surface 134 reflect the second frequency band signal, and the openings of the corner parts 14 are oriented in different directions, so that the antennas 2 may radiate the second frequency band signal in different directions. Because the third end surface 131, the fourth end surface 132, the fifth end surface 133 and the sixth end surface 134 tilt toward the sky, the second frequency band signal reflected by the third end surface 131, the fourth end surface 132, the fifth end surface 133 and the sixth end surface 134 is mostly radiated to a direction obliquely above the metal body 1, to improve the strength of the second frequency band signal obliquely above the metal body 1. The antenna controls the work of antennas 2 by using the switching component 3, to enable the second frequency band signal radiated by the base station 100 to cover all directions on the horizontal plane. Referring to FIG. 12, the base station 100 has good circuit performance in a frequency range from 1.34 to 1.45 GHz. With reference to FIG. 14, a line indicated by a horizontal plane pattern of the antenna 1 in FIG. 14 represents directivity of the antenna 1 on the horizontal plane, a line indicated by a horizontal plane pattern of the antenna 2 in FIG. 14 represents directivity of the antenna 2 on the horizontal plane, a line indicated by a horizontal plane pattern of the antenna 3 in FIG. 14 represents directivity of the antenna 3 on the horizontal plane, a line indicated by a horizontal plane pattern of the antenna 4 in FIG. 14 represents directivity of the antenna 4 on the horizontal plane and a line indicated by a horizontal plane pattern envelope in FIG. 14 represents directivity of the base station 100 on the horizontal plane. The line indicated by the horizontal plane pattern envelope is formed by combining parts with best radiation effects of the antenna 1, the antenna 2, the antenna 3, and the antenna 4. It can be learned from FIG. 14 that the second frequency band signal radiated by the base station 100 has omnidirectionality on the horizontal plane.

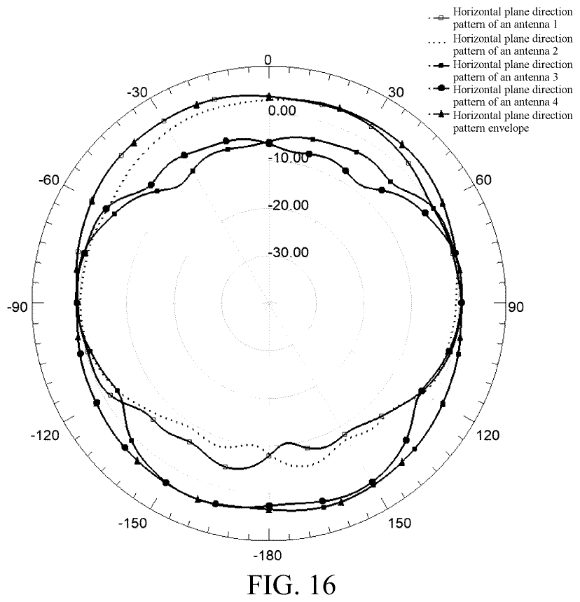

(3) For the third frequency band, the base station 100 makes the second surface 2513 of the second dielectric plate 251 in each antenna 2 orient to the space out of the corner part 14 to dispose the third feeding part 2511 and the fourth feeding part 2512 that are separated from each other on the second surface 2513, connects the third feeding part 2511 to the second inner conductor 2521 of the second feedline 252, connects the second outer conductor 2522 of the second feedline 252 to the fourth feeding part 2512, connects one end of the eighth radiating arm 2531 to the third feeding part 2511, connects one end of the ninth radiating arm 2532 to the fourth feeding part 2512 and disposes both the reflector 255 and the director 256 on the second surface 2513. The eighth radiating arm 2531 and the ninth radiating arm 2532 are located between the reflector 255 and the director 256, so that antennas 2 can radiate the third frequency band signal in different directions. The work of each antenna 2 is controlled by using the switching component 3, to enable the third frequency band signal radiated by the base station 100 to cover all directions on the horizontal plane. Referring to FIG. 15, the base station 100 has good circuit performance in a frequency range from 2.23 to 2.57 GHz. With reference to FIG. 16, a line indicated by a horizontal plane pattern of the antenna 1 in FIG. 16 represents directivity of the antenna 1 on the horizontal plane, a line indicated by a horizontal plane pattern of the antenna 2 in FIG. 16 represents directivity of the antenna 2 on the horizontal plane, a line indicated by a horizontal plane pattern of the antenna 3 in FIG. 16 represents directivity of the antenna 3 on the horizontal plane, a line indicated by a horizontal plane pattern of the antenna 4 in FIG. 16 represents directivity of the antenna 4 on the horizontal plane and a line indicated by a horizontal plane pattern envelope in FIG. 16 represents directivity of the base station 100 on the horizontal plane. The line indicated by the horizontal plane pattern envelope is formed by combining parts with best radiation effects of the antenna 1, the antenna 2, the antenna 3, and the antenna 4. It can be learned from FIG. 16 that the third frequency band signal radiated by the base station 100 has omnidirectionality on the horizontal plane.

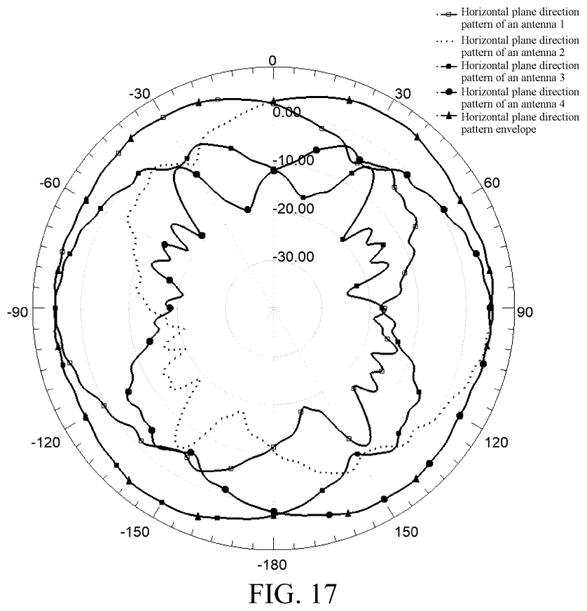

(4) For the fourth frequency band, the base station 100 makes the second surface 2513 of the second dielectric plate 251 in each antenna 2 orient to the space out of the corner part 14 to dispose the third feeding part 2511 and the fourth feeding part 2512 that are separated from each other on the second surface 2513, connects the third feeding part 2511 to the second inner conductor 2521 of the second feedline 252, connects the second outer conductor 2522 of the second feedline 252 to the fourth feeding part 2512, connects one end of the tenth radiating arm 2541 to the third feeding part 2511, connects one end of the eleventh radiating arm 2542 to the fourth feeding part 2512 and disposes both the reflector 255 and the director 256 on the second surface 2513. The tenth radiating arm 2541 and the eleventh radiating arm 2542 are located between the reflector 255 and the director 256, so that antennas 2 can radiate the fourth frequency band signal in different directions. The work of antennas 2 is controlled by using the switching component 3, to enable the fourth frequency band signal radiated by the base station 100 to cover all directions on the horizontal plane. Referring to FIG. 15, the base station 100 has good circuit performance in a frequency range from 5.44 to 5.88 GHz. With reference to FIG. 17, a line indicated by a horizontal plane pattern of the antenna 1 in FIG. 17 represents directivity of the antenna 1 on the horizontal plane, a line indicated by a horizontal plane pattern of the antenna 2 in FIG. 17 represents directivity of the antenna 2 on the horizontal plane, a line indicated by a horizontal plane pattern of the antenna 3 in FIG. 17 represents directivity of the antenna 3 on the horizontal plane, a line indicated by a horizontal plane pattern of the antenna 4 in FIG. 17 represents directivity of the antenna 4 on the horizontal plane and a line indicated by a horizontal plane pattern envelope in FIG. 17 represents directivity of the base station 100 on the horizontal plane. The line indicated by the horizontal plane pattern envelope is formed by combining parts with best radiation effects of the antenna 1, the antenna 2, the antenna 3, and the antenna 4. It can be learned from FIG. 17 that the fourth frequency band signal radiated by the base station 100 has omnidirectionality on the horizontal plane.

In this embodiment of the present disclosure, at least two antennas 2 are all disposed on the metal body 1, the at least two antennas 2 are all connected to the switching component 3 and the at least two antennas 2 are oriented in different directions, to enable a combination of directions of signals radiated by the at least two antennas 2 to cover all directions on the horizontal plane. Then, the antenna with the strongest signal among the at least two antennas 2 works by using the switching component 3, so that a size of a single antenna is greatly reduced while omnidirectional coverage of a signal radiated by the base station 100 on the horizontal plane is achieved, which helps reduce the overall volume of the base station 100.

Alternatively, the metal body includes a bracket, a metal chamber and two metal panels. The metal chamber and the two metal panels are all mounted on the bracket, the two metal panels are respectively located at two ends of the metal chamber, four corner parts are formed between the metal chamber and the two metal plates and orientations of the four corner parts are different. A quantity of antennas is four and one antenna is disposed on one corner part to enable the corner part to reflect a signal radiated by the antenna and a combination of directions of signals radiated by the four antennas to cover all directions on the horizontal plane.

Alternatively, none of length directions of the at least two antennas is perpendicular to the horizontal plane.

Alternatively, the antenna includes an antenna bracket and a first radiating module, the antenna bracket is disposed at the corner part, the first radiating module is disposed on the antenna bracket, the first radiating module is connected to the switching component and the first radiating module is configured to radiate a first frequency band signal and a second frequency band signal.

Alternatively, the first radiating module includes a first dielectric plate, a first feedline and a first radiating assembly. The first dielectric plate is mounted on the antenna bracket, the first radiating assembly is disposed on a first surface of the first dielectric plate, the first surface is oriented to a corner of the corner part, one end of the first feedline is electrically connected to the first radiating assembly, the other end of the feedline is connected to the switching component, the first radiating assembly is configured to radiate the first frequency band signal and a metal wall of the corner part has a reflection effect on the first frequency band signal, to improve strength of the first frequency band signal above the metal body.

Alternatively, a first feeding part and a second feeding part are disposed on the first dielectric plate. The first feeding part and the second feeding part are disposed separately, the first feedline includes a first inner conductor and a first outer conductor, the first inner conductor and the first outer conductor are disposed in an insulated manner, the first inner conductor is electrically connected to the first feeding part, the first outer conductor is electrically connected to the second feeding part and the first radiating assembly is connected to the first feeding part and the second feeding part separately.

Alternatively, the first radiating assembly includes a first radiating arm, a second radiating arm and a third radiating arm. One end of the first radiating arm is connected to the first feeding part, one end of the second radiating arm and one end of the third radiating arm are both connected to the second feeding part and the first radiating arm, the second radiating arm and the third radiating arm are collectively configured to radiate the first frequency band signal.

Alternatively, the first radiating assembly further includes a first stub, a second stub and a third stub. The first stub is connected to the other end of the first radiating arm, the second stub is connected to the other end of the second radiating arm and the third stub is connected to the other end of the third radiating arm.

Alternatively, the first radiating module further includes a second radiating assembly and the second radiating assembly includes a fourth radiating arm, a fifth radiating arm, a sixth radiating arm and a seventh radiating arm. One end of the fourth radiating arm and one end of the fifth radiating arm are both connected to the first feeding part and the fourth radiating arm and the fifth radiating arm are respectively located on two sides of the first radiating arm; one end of the sixth radiating arm and one end of the seventh radiating arm are both connected to the second feeding part, the sixth radiating arm is located on a side of the second radiating arm away from the third radiating arm and the seventh radiating arm is located on a side of the third radiating arm away from the second radiating arm; and the fourth radiating arm, the fifth radiating arm, the sixth radiating arm and the seventh radiating arm are collectively configured to radiate the second frequency band signal, and the metal wall of the corner part has a reflection effect on the second frequency band signal, to improve strength of the second frequency band signal above the metal body.

Alternatively, the antenna further includes a duplexer assembly, a feedline bus and a second radiating module. The second radiating module is disposed on the antenna bracket, the first radiating module and the second radiating module are both connected to the duplexer assembly, one end of the feedline bus is connected to the duplexer assembly, the other end of the feedline bus is connected to the switching component and the second radiating module is configured to radiate a third frequency band signal and a fourth frequency band signal.

Alternatively, the second radiating module includes a second dielectric plate, a second feedline, and a third radiating assembly. The second dielectric plate is mounted on the antenna bracket, the third radiating assembly is disposed on a second surface of the second dielectric plate, the second surface is oriented outwards through an opening of the corner part, one end of the second feedline is connected to the third radiating assembly, the other end of the second feedline is connected to the duplexer assembly and the third radiating assembly is configured to radiate the third frequency band signal.

Alternatively, a third feeding part and a fourth feeding part are disposed on the second dielectric plate. The third feeding part and the fourth feeding part are disposed separately, the second feedline includes a second inner conductor and a second outer conductor, the second inner conductor is electrically connected to the third feeding part, the second outer conductor is electrically connected to the fourth feeding part and the third feeding part and the fourth feeding part are both connected to the third radiating assembly.

Alternatively, the third radiating assembly includes an eighth radiating arm and a ninth radiating arm. One end of the eighth radiating arm is connected to the third feeding part, one end of the ninth radiating arm is connected to the fourth feeding part and the eighth radiating arm and the ninth radiating arm are collectively configured to radiate the third frequency band signal.

Alternatively, the second radiating module further includes a reflector. The reflector is disposed on the second dielectric plate, and is in perpendicular to a length direction of the eighth radiating arm, projections of the eighth radiating arm and the ninth radiating arm both fall within a projection of the reflector and the reflector is configured to reflect the third frequency band signal radiated by the third radiating assembly in a direction of the opening of the corner part.

Alternatively, the second radiating module further includes a director. The director is disposed on the second dielectric plate and the third radiating assembly is located between the reflector and the director.

Alternatively, the second radiating module further includes a fourth radiating assembly and the fourth radiating assembly includes a tenth radiating arm and an eleventh radiating arm. One end of the tenth radiating arm is connected to the third feeding part, the eleventh radiating arm is connected to the fourth feeding part, the tenth radiating arm and the eleventh radiating arm are collectively configured to radiate the fourth frequency band signal and the reflector is further configured to reflect the fourth frequency band signal radiated by the fourth radiating assembly in a direction of the opening of the corner part.

Beneficial effects of embodiments of the present disclosure are that different from the prior art, embodiments of the present disclosure provide at least two corner parts oriented in different directions on the metal body and one antenna is disposed on one corner part to enable the combination of the directions of the signals radiated by the at least two antennas to cover all directions on the horizontal plane. The at least two antennas are connected to the switching component and the antenna enables the antenna with the strongest signal in the at least two antennas to work by using the switching component, so that a size of a single antenna is greatly reduced while omnidirectional coverage of signals radiated by the base station on the horizontal plane is achieved, which helps reduce an overall volume of the base station.

The foregoing descriptions are merely embodiments of the present disclosure, and are not intended to limit the patent scope of the present disclosure. An equivalent structure or an equivalent process transformation made by using content of the specification and the accompanying drawings of the present disclosure, or directly or indirectly used in other related technical fields, is included in the patent protection scope of the present disclosure.

What is claimed is:

1. A base station, comprising:
a metal body, provided with at least two corner parts, wherein the at least two corner parts are oriented in different directions;
at least two antennas, wherein the at least two antennas is respectively disposed at least two corner parts and the two corner parts is configured to reflect a signal radiated by the antenna to enable a combination of directions of signals radiated by the at least two antennas to cover all directions on a horizontal plane; and
a switching component, wherein the at least two antennas are all connected to the switching component to enable an antenna with a strongest signal among the at least two antennas to work.

2. The base station according to claim 1, wherein
the metal body comprises a bracket, a metal chamber and two metal panels, wherein the metal chamber and the two metal panels are mounted on the bracket, the two metal panels are respectively located at two ends of the metal chamber, four corner parts are formed between the metal chamber and the two metal panels and orientations of the four corner parts are different; and
a quantity of the antennas is four and one antenna is respectively disposed on one corner part to enable a combination of directions of signals radiated by the four antennas to cover all directions on the horizontal plane.

3. The base station according to claim 1, wherein
The at least two antennas are oriented such that their length directions are not perpendicular to the horizontal plane.

4. The base station according to claim 1, wherein
the antenna comprises an antenna bracket and a first radiating module, the antenna bracket is disposed at the corner part, the first radiating module is disposed on the antenna bracket, the first radiating module is connected to the switching component and the first radiating module is configured to radiate a first frequency band signal and a second frequency band signal.

5. The base station according to claim 4, wherein
the first radiating module comprises a first dielectric plate, a first feedline and a first radiating assembly, wherein the first dielectric plate is mounted on the antenna bracket, the first radiating assembly is disposed on a first surface of the first dielectric plate, the first surface is oriented to a corner of the corner part, one end of the first feedline is electrically connected to the first radiating assembly, the other end of the first feedline is connected to the switching component, the first radiating assembly is configured to radiate the first frequency band signal and a metal wall of the corner part has a reflection effect on the first frequency band signal, to improve strength of the first frequency band signal above the metal body.

6. The base station according to claim 5, wherein
a first feeding part and a second feeding part are disposed on the first dielectric plate, wherein the first feeding part and the second feeding part are disposed separately, the first feedline comprises a first inner conductor and a first outer conductor, the first inner conductor and the first outer conductor are disposed in an insulated manner, the first inner conductor is electrically connected to the first feeding part, the first outer conductor is electrically connected to the second feeding part and the first radiating assembly is connected to the first feeding part and the second feeding part separately.

7. The base station according to claim 6, wherein
the first radiating assembly comprises a first radiating arm, a second radiating arm and a third radiating arm, wherein one end of the first radiating arm is connected to the first feeding part, one end of the second radiating arm and one end of the third radiating arm are both connected to the second feeding part and the first radiating arm, the second radiating arm and the third radiating arm are collectively configured to radiate the first frequency band signal.

8. The base station according to claim 7, wherein
the first radiating assembly further comprises a first stub, a second stub and a third stub, wherein the first stub is connected to the other end of the first radiating arm, the second stub is connected to the other end of the second radiating arm and the third stub is connected to the other end of the third radiating arm.

9. The base station according to claim 6, wherein
the first radiating module further comprises a second radiating assembly and the second radiating assembly comprises a fourth radiating arm, a fifth radiating arm, a sixth radiating arm and a seventh radiating arm, wherein one end of the fourth radiating arm and one end of the fifth radiating arm are both connected to the first feeding part and the fourth radiating arm and the fifth radiating arm are respectively located on two sides of the first radiating arm; one end of the sixth radiating arm and one end of the seventh radiating arm are both connected to the second feeding part, the sixth radiating arm is located on a side of the second radiating arm away from the third radiating arm and the seventh radiating arm is located on a side of the third radiating arm away from the second radiating arm; and the fourth radiating arm, the fifth radiating arm, the sixth radiating arm and the seventh radiating arm are collectively configured to radiate the second frequency band signal and the metal wall of the corner part has a reflection effect on the second frequency band signal, to improve strength of the second frequency band signal above the metal body.

10. The base station according to claim 4, wherein
the antenna further comprises a duplexer assembly, a feedline bus and a second radiating module, wherein the second radiating module is disposed on the antenna bracket, the first radiating module and the second radiating module are both connected to the duplexer assembly, one end of the feedline bus is connected to the duplexer assembly, the other end of the feedline bus is connected to the switching component and the second radiating module is configured to radiate a third frequency band signal and a fourth frequency band signal.

11. The base station according to claim 10, wherein
the second radiating module comprises a second dielectric plate, a second feedline and a third radiating assembly, wherein the second dielectric plate is mounted on the antenna bracket, the third radiating assembly is disposed on a second surface of the second dielectric plate, the second surface is oriented outwards through an opening of the corner part, one end of the second feedline is connected to the third radiating assembly, the other end of the second feedline is connected to the duplexer assembly and the third radiating assembly is configured to radiate the third frequency band signal.

12. The base station according to claim 11, wherein
a third feeding part and a fourth feeding part are disposed on the second dielectric plate, wherein the third feeding part and the fourth feeding part are disposed separately, the second feedline comprises a second inner conductor and a second outer conductor, the second inner conductor is electrically connected to the third feeding part, the second outer conductor is electrically connected to the fourth feeding part and the third feeding part and the fourth feeding part are both connected to the third radiating assembly.

13. The base station according to claim 12, wherein
the third radiating assembly comprises an eighth radiating arm and a ninth radiating arm, wherein one end of the eighth radiating arm is connected to the third feeding part, one end of the ninth radiating arm is connected to the fourth feeding part and the eighth radiating arm and the ninth radiating arm are collectively configured to radiate the third frequency band signal.

14. The base station according to claim 13, wherein
the second radiating module further comprises a reflector, wherein the reflector is disposed on the second dielectric plate and is in perpendicular to a length direction of the eighth radiating arm, projections of the eighth radiating arm and the ninth radiating arm both fall within a projection of the reflector and the reflector is configured to reflect the third frequency band signal radiated by the third radiating assembly in a direction of the opening of the corner part.

15. The base station according to claim 14, wherein
the second radiating module further comprises a director, wherein the director is disposed on the second dielectric plate and the third radiating assembly is located between the reflector and the director.

16. The base station according to claim 14, wherein
the second radiating module further comprises a fourth radiating assembly and the fourth radiating assembly comprises a tenth radiating arm and an eleventh radiating arm, wherein one end of the tenth radiating arm is connected to the third feeding part, the eleventh radiating arm is connected to the fourth feeding part, the tenth radiating arm and the eleventh radiating arm are collectively configured to radiate the fourth frequency band signal and the reflector is further configured to reflect the fourth frequency band signal radiated by the fourth radiating assembly in a direction of the opening of the corner part.

17. The base station according to claim 1, wherein
the switching component comprises a controller, at least two signal detectors and at least two switching assembly, one signal detector is respectively connected to one antenna, and the signal detectors are connected to the controller.

18. The base station according to claim 1, wherein
signal detector is respectively configured to detect strength of the antenna connected to the signal detector, the controller receives the strength of the signals detected by the signal detectors;
the controller controls a switching assembly connected to an antenna with a strongest signal to be turned on and the controller controls the remain switching assembly to be turned off.
